(19) United States
(12) Patent Application Publication
(10) Pub. No.: US 2015/0361926 A1
(43) Pub. Date: Dec. 17, 2015

(54) INCREASED DIESEL ENGINE EFFICIENCY BY USING NITROUS OXIDE AS A FUEL ADDITIVE

(71) Applicants: Richard ECKHARDT, Arlington, MA (US); COMBUSTION 8 TECHNOLOGIES LLC, Butler, WI (US)

(72) Inventors: Richard Eckhardt, Arlington, MA (US); Larry Daniel Nichols, Arlington, MA (US); David B. Cope, Medfield, MA (US)

(21) Appl. No.: 14/762,868

(22) PCT Filed: Jan. 23, 2014
(86) PCT No.: PCT/US2014/012695

§ 371 Date: Jul. 23, 2015

Related U.S. Application Data
(60) Provisional application No. 61/755,730, filed on Jan. 23, 2013.

(51) Int. Cl. F02M 25/00; F02M 37/08

(52) U.S. Cl. CPC F02M 25/00; F02M 37/08

(57) ABSTRACT

A diesel engine fuel delivery system is equipped for addition of N₂O to the fuel supply of a diesel engine. Fuel from a tank passes through an outlet tube to a low pressure pump which delivers it through a fuel filter. Simultaneously liquid N₂O from a pressurized tank passes through a metering valve where it merges with the fuel before passing through a high, constant pressure, on-demand pump. The N₂O-loaded fuel then enters a high pressure manifold, called a common rail, where its pressure is monitored by a sensor before it enters individual injectors which spray it, with proper timing into the combustion zone of each cylinder. The desired fuel injection timing can be adjusted and controlled by an electronic engine control unit similar to those commonly installed on modern vehicular diesel engines.

### CROSS-REFERENCE TO RELATED APPLICATIONS

This application claims benefit of Provisional Application No. 61/755,730 filed on Jan. 23, 2013, the entire content of which is incorporated herein by reference.

### FIELD OF THE INVENTION

This invention relates to methods and apparatus for increasing diesel engine efficiency, and more particularly to improving diesel engine efficiency by using nitrous oxide as a fuel additive.

### BACKGROUND

Diesel engines power many automobiles and most commercial trucks in the United States, as well as most stationary generators. Their efficient operation is a matter of great importance economically, environmentally, and in terms of petroleum conservation.

A diesel engine is a type of compression ignition internal combustion engine (ICE) in which a liquid hydrocarbon fuel is sprayed directly into hot compressed air near the top of the compression stroke. Upon spraying, the fuel begins to vaporize and, in due course, to undergo spontaneous ignition and combustion. Gas heated to high temperatures and high pressures by the combustion of the fuel exerts a force on the piston, thereby converting the heat of combustion into useful mechanical work which can be delivered through the crankshaft to an external load.

FIGS. 1A-D illustrate the sequence of strokes of a piston 120 in a cylinder 110—intake (FIG. 1A), compression (FIG. 1B), power (FIG. 1C), and exhaust (FIG. 1D)—by which a four-cycle Diesel ICE operates. During the intake stroke, shown in FIG. 1A, air (indicated by arrow 122) is drawn into the chamber 115 of the cylinder 110 as the intake valve 130 opens and the piston 120 descends (indicated by arrow 124). During the following compression stroke, shown in FIG. 1B, both the valve 130 and the exhaust valve 140 are closed and the rising (indicated by arrow 126) piston 120 compresses the air, increasing its pressure and temperature. Liquid hydrocarbon fuel 150 is then injected under high pressure directly into the hot compressed air when piston 120 is near top dead center (TDC). Note that while a 4-cycle engine is described, the principles disclosed herein can be applied to other types of engine (e.g., 2-cycle engines).

The injected fuel immediately begins to vaporize and in due course to burn in the chamber 115. The resulting release of heat energy causes a large additional increase in temperature and pressure, which forces the piston 120 downward (indicated by arrow 128) during the power stroke as illustrated in FIG. 1C. Finally, the exhaust valve 140 opens as shown in FIG. 1D, venting and expelling the chamber 115 contents (indicated by arrow 132) in preparation for the next intake stroke.

Diesel fuels, including petroleum based fuels, biodiesel fuels, and other fuels susceptible to compression ignition, are generally less volatile than the gasoline used in spark ignition engines because they are intended for vaporization at much higher temperatures. Diesel fuel generally contains normal and branched alkanes as well as cycloparaffins and aromatic hydrocarbons. As compared to gasoline, diesel fuel contains a larger fraction of straight chain hydrocarbons which readily auto-ignite when heated. Auto-ignition is necessary in a diesel engine, but can lead to knocking in a spark-ignition engine operating at a high load. Diesel engines are designed to operate with a large excess of air, and for that reason burn more than 99% of the injected fuel, leading to low levels of unburned hydrocarbon emissions.

For combustion temperatures attainable in conventional diesel engines the Second Law of Thermodynamics does not allow more than about 65% of the heat of combustion to be converted into useful work. The actual efficiency is further reduced by in-cylinder heat losses to the cooling system, enthalpy wasted as residual heat, pressure and kinetic energy in the exhaust, and mechanical friction. As a result, most vehicular diesel engines convert only 30% to 40% of the heat of combustion into useful mechanical work.

For the reasons set forth above, methods and systems that allow utilization of a larger fraction of the available energy in diesel fuel would provide an economically valuable increase in power and mileage, as well as associated environmental and fuel conservation benefits.

### SUMMARY

In general, in a first aspect, the invention features a method for improving the efficiency of a diesel engine that includes mixing nitrous oxide in diesel fuel to provide modified fuel, and timing injection of the modified fuel into a combustion chamber of the diesel engine with a cylinder stroke to enhance ignition and reduce fuel consumption of the diesel engine relative to using unmodified diesel fuel.

Implementations of this method may include one or more of the following features:

The timing can be selected so that ignition occurs within about 10° after top dead center (e.g., within about 8°, within about 5°, within 3°, within 2°, within 1°). A concentration of nitrous oxide in the modified fuel can be between 0.02% and 2.0% by weight (e.g., about 0.02%, 0.05%, about 1.5%, about 2.0%, e.g., between 0.1% and 1.0%, such as about 0.1%, about 0.2%, about 0.3%, about 0.4%, about 0.5%, about 0.6%, about 0.7%, about 0.8%, about 0.9%, about 1.0%). The nitrous oxide can be stored as a compressed liquid in a pressurized tank prior to dissolving in the diesel fuel. Diesel fuel can be delivered to the combustion chamber first through a low pressure pump and then through a high pressure pump and the nitrous oxide, in liquid form, can be introduced into the diesel fuel through a metering valve between the low pressure pump and the high pressure pump. A driving pressure for flow through the metering valve can be an autogenous pressure of the liquid nitrous oxide. The diesel fuel can be stored in a fuel tank and the high pressure pump can be an on-demand constant pressure pump configured to prevent return of the modified fuel to the fuel tank. A metering valve can operate based on a rate of flow of the diesel fuel to produce a constant concentration of nitrous oxide in the modified fuel. The metering valve can be keyed to the rate of flow of the diesel fuel and to a RPM and load of the engine to produce an optimum concentration of nitrous oxide in the modified fuel. The metering valve and the timing of fuel injection can be controlled using an electronic processing system that includes stored instructions and electronic sensors that regulate injection timing and nitrous oxide concentration in the modified fuel to adjust both diesel fuel consumption and nitrous oxide consumption. An accumulator can be included after the introduction of nitrous oxide in the fuel line between the low pressure pump and the high pressure pump. The high pressure pump can operate at a constant volumetric rate. The engine can deliver the modified fuel to the combustion chamber via a common rail and excess modified fuel can exit the common rail through a pressure relief valve and return to an inlet side of the high pressure pump. The engine can include a common rail configured to deliver the modified fuel to the combustion chamber, one or more high-pressure solenoid pumps operated by an electronic control unit, and delivery of the mixed fuel to the combustion chamber can include using the solenoid pumps to deliver minute, accurately calibrated pulses of N₂O to fuel lines leading from the common rail to the combustion chamber.

In general, in another aspect, the invention features a system that includes a diesel internal combustion engine including at least one combustion chamber, and a means for mixing nitrous oxide in diesel fuel to form modified fuel and controlling a time at which the modified fuel is injected into the combustion chamber to enhance ignition and reduce fuel consumption of the diesel engine relative to using unmodified diesel fuel.

Implementations of this aspect may include one or more of the following features and/or features of other aspects:

The system can control the time so that resulting ignition occurs within about 5° to 10° after top dead center. The system can mix the nitrous oxide so that the concentration of nitrous oxide in the modified fuel is between 0.1% and 1.0% by weight. The system can include a pressure-resistant tank where the nitrous oxide is stored as a pressurized liquid. The system can include a metering valve for introducing the nitrous oxide into a fuel line. The system can include a high pressure pump and a low pressure pump for delivering diesel to the combustion chamber, where the metering valve is located between the low pressure pump and the high pressure pump. The high pressure pump can be an on-demand constant pressure pump configured to prevent return of the modified fuel to a fuel tank supplying the diesel fuel. The system can include a means whereby the metering valve operates based on a rate of flow of the diesel fuel to produce a constant concentration of nitrous oxide in the modified fuel. The system can include a means whereby the metering valve operates based on a rate of flow of the diesel fuel and to a RPM and load of the engine to produce an optimum concentration of nitrous oxide in the modified fuel. The system can include an electronic processing system that includes stored instructions and electronic sensors which control injection timing and nitrous oxide concentration in the modified fuel adjust diesel fuel consumption and nitrous oxide consumption.

In general, in another aspect, a system includes a diesel internal combustion engine that includes a low-pressure pump and a high-pressure pump for delivering diesel fuel to at least one combustion chamber via a common rail, the high-pressure pump being configured to operate at a constant volumetric rate. The system also includes a tank containing nitrous oxide and a supply module arranged to supply nitrous oxide from the tank to a fuel line between the low-pressure pump and the high-pressure pump, where the nitrous oxide mixes with diesel fuel in the fuel line to provide modified fuel. The system also includes an accumulator in the fuel line between the low-pressure and high-pressure pumps downstream from where the nitrous oxide is introduced. The system also includes a return line for returning to an inlet side of the high-pressure pump modified fuel exiting the common rail through a pressure relief valve. The system may be configured to implement the method of the first aspect.

In general, in another aspect, the invention features a system that includes a diesel internal combustion engine that includes one or more fuel injectors which receive fuel via a common rail, a tank containing nitrous oxide, one or more high-pressure solenoid pumps, and an electronic control unit in communication with the high-pressure solenoid pumps. During operation the electronic control unit causes the solenoid pumps to deliver calibrated pulses of nitrous oxide to one or more fuel lines leading from the common rail to each fuel injector. The system may be configured to implement the method of the first aspect.

Among other advantages, the systems and methods may provide substantial improvement in efficiency and/or performance of diesel engines or other internal combustion engines.

### BRIEF DESCRIPTION OF THE DRAWINGS

These and other features, aspects, and advantages of the present invention will become better understood with regard to the following description, appended claims and accompanying drawings, in which like reference numbers indicate like features, and wherein:

FIGS. 1A-D show a sequence of strokes of an example piston in a cylinder.

FIGS. 2A-B show example results from a model used to determined thermodynamic efficiency of an engine.

FIG. 3 shows an example diesel engine fuel delivery system.

FIG. 4 shows another example diesel engine fuel delivery system.

FIG. 5 shows another example diesel engine fuel delivery system.

FIG. 6 shows an example system for determining the improvement in mileage of a diesel vehicle produced by a concentration of N₂O in a fuel supply.

### DETAILED DESCRIPTION

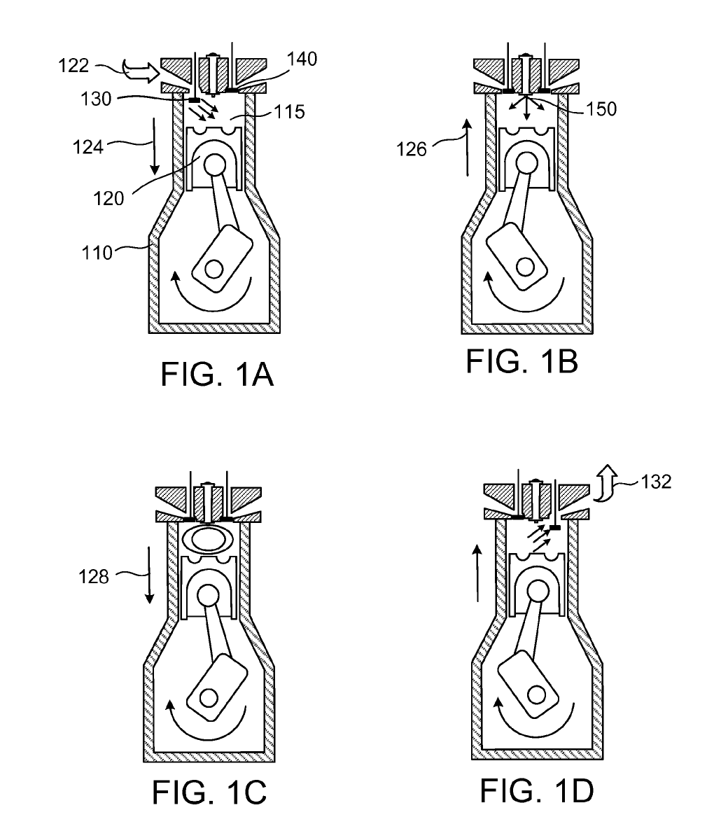

Both cooling system losses and exhaust losses in an ICE are determined by the in-cylinder pressure and temperature profile, which depends on the RPM, the time and duration of injection, the ignition delay, and the rate of burn. Referring again to FIGS. 1A-D, if ignition and combustion occur too early, the gas can lose too much heat to the cooling system during the compression stroke, before the power stroke even begins. If ignition and combustion occur too late, the hot gas can do work on the cylinder only during a late portion of the expansion stroke, wasting power when hot gas, still under pressure and possibly incompletely burned, is vented to the exhaust. Thus the proper onset and duration of combustion are critical to the efficient operation of a diesel engine.

To some extent the duration and speed of combustion can be controlled by the timing and rate of fuel injection and the spray nozzle configuration, but this approach is limited in scope because the combustion profile is also influenced by engine parameters such as stroke, bore, and RPM, and by fuel parameters such as cetane number, a measurement of intrinsic ignition delay.

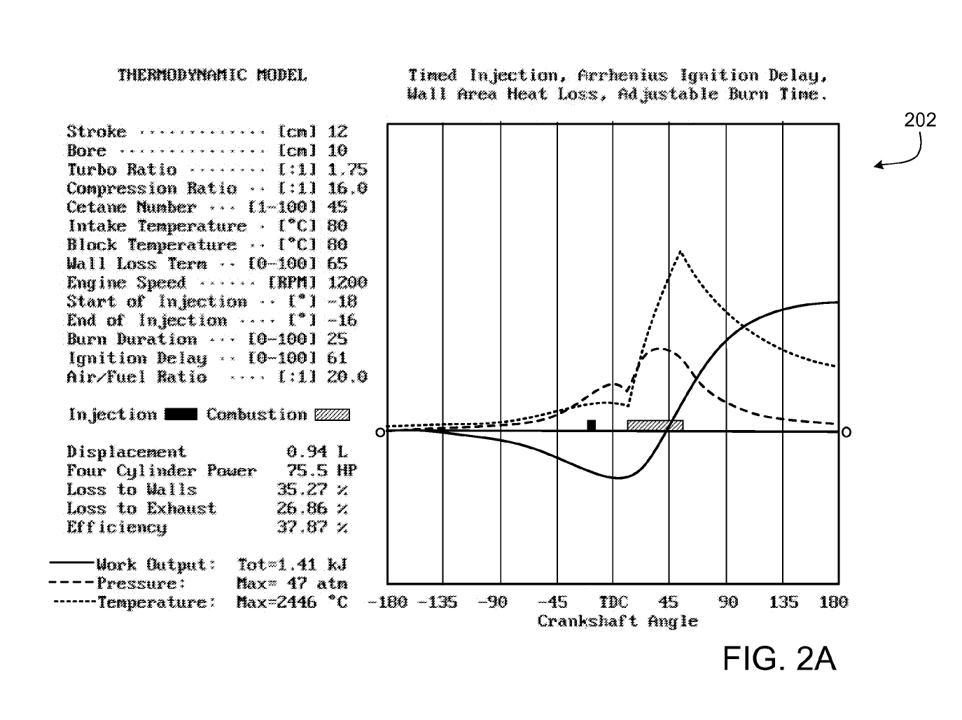

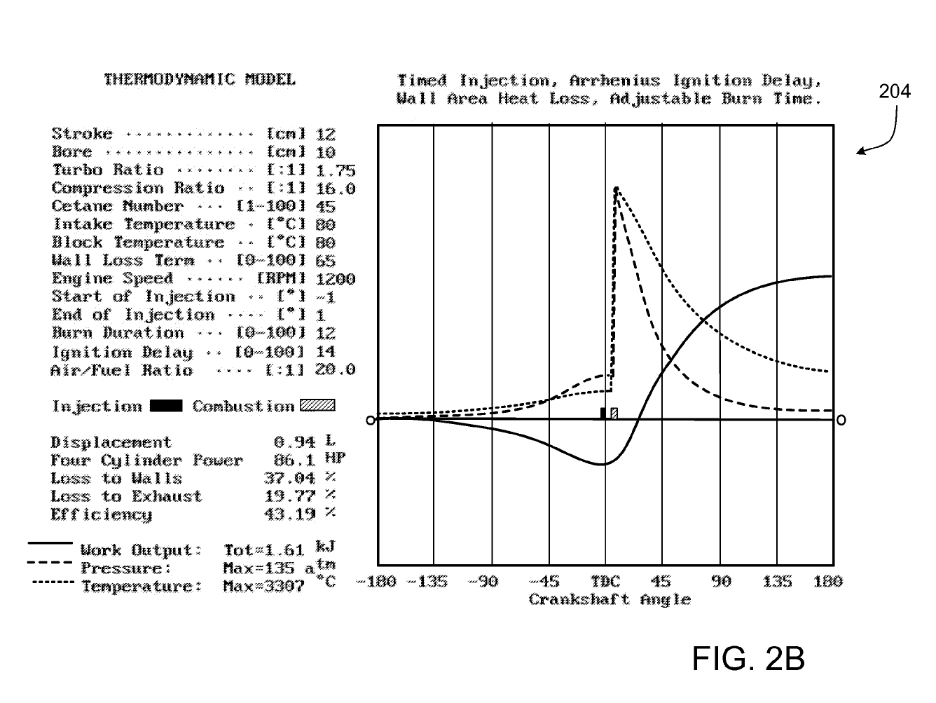

The interplay of these many factors can be modeled by simple stepwise computer programs which trace the history of temperature, pressure, heat loss and mechanical work as determined by the laws of ideal gas theory, thermodynamics, and heat flow. Calculations based on such models show that optimum efficiencies can achieved when rapid combustion is initiated shortly after TDC. FIGS. 2A-B are printouts of results 202 and 204 from one such model showing how the thermodynamic efficiency of a typical diesel engine can be increased from 37.9% to 43.2% when the onset of combustion is advanced from 10° to 5° after TDC, and completion of combustion is advanced from 55° to 10° after TDC. This improvement would be manifest as a 14.0% increase in power at the same fuel consumption. Here the phrase “thermodynamic efficiency” designates the frictionless work delivered by the engine, for example in kilojoules, divided by the thermal energy content of the consumed fuel expressed in the same units.

The results 202 and 204 in FIGS. 2A-B are based on a model of Diesel performance patterned after the Carnot cycle. Each 0.1° iterative step is treated as an adiabatic process modified by a constant rate of heat input from the burning fuel. The rate of heat loss to the cooled cylinder walls is treated as proportional to (wall area) x (temperature difference), and an Arrhenius equation τ=AP⁻¹e^{B/T} is used to calculate the ignition delay ti at each temperature T and pressure P. The activation energy term B=618,840/(CN+25) is adjusted to reflect the ignition activation energy of the fuel, based on its cetane number (CN), and ignition is assumed to occur when ∫(dt/τ)=1. Heat released once the fuel ignites is distributed over a number of successive intervals determined by the duration of combustion as predicted by a similar Arrhenius equation (See, e.g., Equations (10.35), (10.38) and (10.36) in “Internal Combustion Engine Fundamentals,” John B. Heywood, McGraw-Hill, Inc. (1988)). Frictional losses have not been included in the above model; they would lead to a modest increase in the calculated percentage improvement.

Because models such as this reveal a considerable advantage in efficiency for combustion which begins and concludes shortly after TDC, that is the target at which methods for achieving better combustion should aim. To do that, some of the factors controlling the onset and rate of combustion should be modified. The presence one chemical species, atomic oxygen, in the immediate vicinity of the evaporating fuel is believed to be important to rapid combustion. It is further believed that the concentration of atomic oxygen can be greatly increased by photodissociation of oxygen molecules using a properly timed pulse of ultraviolet (UV) light of appropriate wavelength (i.e., having a sufficiently short wavelength).

An important factor controlling combustion is believed to be the nature of the oxidizing species encountered by the fuel. Normally the only such species is molecular oxygen, O₂, which for quantum mechanical reasons reacts relatively slowly with fuel molecules. Oxygen atoms would be capable of reacting more rapidly, but engine temperatures are not high enough to dissociate O₂ into significant amounts of free O. Thus auto-ignition of diesel fuel during compression must rely on a gradual increase in local temperature caused by relatively slow reactions involving molecular oxygen, such as
R—H+O═O->R.+H—O—O.,
R—H+H—O—O->R.+H—O—O—H,
H—O—O—H->2HO.,
R—H+HO.->R.+H₂O,
R.+O═O->R—O—O., etc.

These reactions continue until they produce a temperature and free radical concentration high enough to initiate an avalanche of chain reactions. At that point ignition occurs and full combustion begins.

While normal combustion in diesel engines is controlled by engine operating conditions and the kinetics of slow reactions involving fuel and O₂ molecules, the situation would be far different if free O atoms were present, because such atoms react far more vigorously with fuel molecules to cause rapid ignition. Heat alone produces very few free O atoms, so diesel combustion can be improved by introducing free O atoms from some other source, when and where they will do the most good.

One way to provide oxygen atoms is by introducing ozone (O₃) as an oxygen atom precursor into the intake airstream. Ozone decomposes on heating to release free oxygen atoms

$${O}_{3 } {heat }_{} {O}_{2} + O$$

with a half-life of 0.1 to 0.5 msec at the temperatures of 400° C. to 600° C. and the pressures of 50 to 125 atmospheres occurring during diesel compression. That rate can be adequate of producing enough oxygen atoms to promote rapid ignition.

Although ozone is generally too unstable to be stored in bulk and then added to the intake airstream, it can be generated in the airstream by an electrical discharge. However, ozone generation in air drawn from the external environment is sensitive to ambient conditions such as temperature and humidity, and it is difficult to produce adequate concentrations of ozone using equipment having a useful service life. For both of these reasons in situ generation of ozone for use in diesels is presently considered unreliable.

In addition to such practical problems, there is another problem associated with the addition of an oxygen atom precursor such as ozone to the intake airstream, because the release of free oxygen atoms is dependent on the chemical properties of the additive and on the operating parameters of the engine, neither of which is susceptible to real-time control. Thus the release of oxygen atoms cannot readily be timed to optimize engine efficiency.

The applicants have realized that the efficacy of oxygen atom production may be optimized by automatically producing O atoms precisely when and where they are needed, namely in the sheath of combustible fuel vapor which envelopes the evaporating fuel droplets shortly after injection. This may be accomplished by introducing a small concentration of nitrous oxide (N₂O) into the fuel just before it enters the combustion chamber. Following injection, the highly volatile N₂O quickly flashes into the vapor phase and begins to generate oxygen atoms.

Introduction of N₂O into the fuel immediately before injection eliminates the need to store, handle, or dispense quantities of N₂O-loaded fuel which could emit N₂O vapor into the atmosphere, where it acts as a greenhouse gas, or into the head space of tanks and storage vessels, where it could pose a safety risk. Instead, the N₂O would be provided in pressurized containers prefilled with the compound in liquid form, ready to be attached to a coupling in the engine compartment. Tanks of liquefied N₂O are classified as safe for public sale and interstate transport. It is believed that liquid N₂O does not cause explosions, and the compound is completely destroyed by diesel combustion, so the described approach fully addresses safety and pollution concerns.

The half life for the dissociation of N₂O in clean air at pressures near 50 bar is believed to be greater than 100 msec at temperatures below about 900° C. Although that seems slow in the context of a compression stroke lasting more than 10 msec, the decomposition of N₂O is believed to be greatly accelerated by the presence of organic fuel molecules, and the decomposition of even a small fraction of the N₂O can lead to enough oxygen atoms to cause spontaneous ignition. Our experience confirms that less than 1% of N₂O dissolved in the fuel has a profoundly beneficial effect on diesel ignition and combustion.

Nitrous oxide is a liquid under pressures of 30 to 70 atmospheres, and can be handled in much the same manner as liquid carbon dioxide. It is commercially available and can be safely transported by conventional carriers. However, at elevated temperatures in the presence of fuel molecules, gaseous N₂O decomposes exothermically into nitrogen molecules, N₂, and oxygen atoms O. Thus, when it is liberated from the fuel spray, it mixes with evaporating fuel vapor and begins to undergo exothermic reactions leading to the initiation of free radical chains and the onset of ignition. A concentration of about 10¹⁵ atoms of O per cubic centimeter has been shown to initiate ignition at temperatures below 300° C. At a typical compression ratio of 16:1 and an air to fuel ratio of 40:1, complete decomposition of 0.33% of N₂O in the fuel produces about 10¹ O atoms per cubic centimeter, and an even higher concentration in the vapor sheath surrounding the fuel spray. Thus under those conditions the decomposition of even a small fraction of the N₂O can cause ignition to occur almost immediately upon injection, thus largely eliminating the lag associated with slow pre-combustion reactions between fuel and molecular oxygen.

This invention should not be confused with the discharge of a pound or more per minute of liquid N₂O into the intake airstream of an internal combustion engines to produce a dramatic power boost for a short period of time. This practice, which is common during competitive performance events, relies on the high oxygen content of N₂O (36%) compared with that of ambient air (21%), and on the increased air density produced by the cooling of the intake airstream by flash evaporation of the injected N₂O. The increase of available oxygen in the intake airstream can be combined with an increase in the amount of injected fuel to raise engine power nearly to the limit set by the mechanical strength of the engine.

In contrast, the invention claimed here does not increase power at the expense of increased fuel consumption, nor does it involve the rapid introduction of large quantities of a combustion promoter. Instead, improvements in mileage of 10% to 25% are economically produced by introducing very small quantities of nitrous oxide along with the injected fuel.

In certain embodiments, a tank of compressed liquid N₂O is provided along with a line connecting that tank with the low pressure fuel feed line, a metering valve or piston and plunger capable of delivering a small but controlled quantity of N₂O into the fuel, and an electronic system capable of controlling the dispensing rate, either maintaining it at a preset value or varying it in response to such engine variables as RPM and air-to-fuel ratio. Generally, the concentration of N₂O in the fuel should be sufficiently high to provide a significant power boost and sufficiently low to allow a few gallons of N₂O to support a several hundred mile trip. Desirable concentrations of N₂O in the fuel typically lie between 0.02% and 2.0% by weight, for example 0.2% to 0.4% by weight.

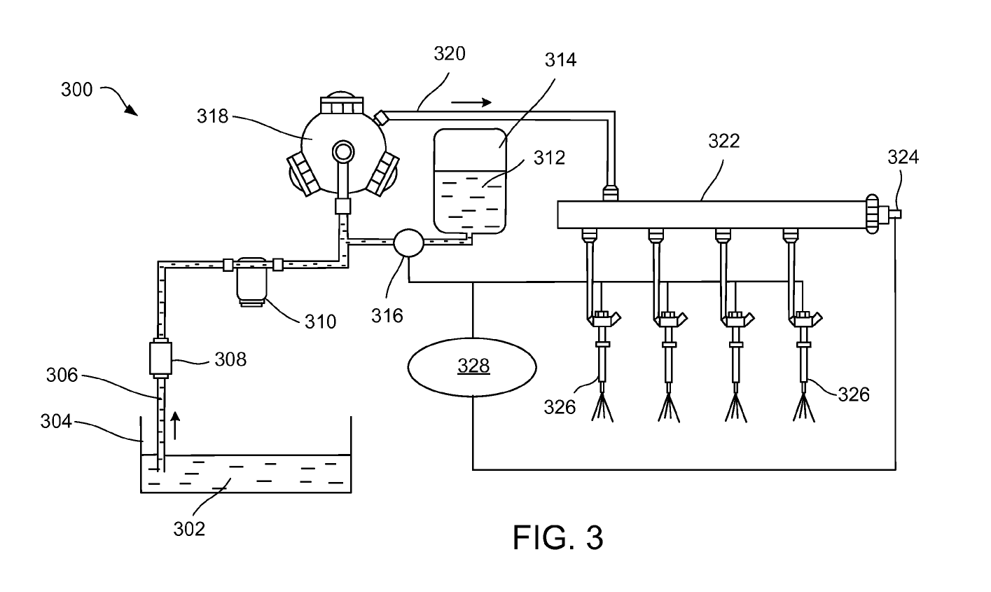

FIG. 3 shows a schematic drawing of a diesel engine fuel delivery system 300 equipped for addition of N₂O to the fuel. Referring to FIG. 3, fuel 302 from tank 304 passes through an outlet tube 306 to a low pressure pump 308 which delivers it through a fuel filter 310. Simultaneously liquid N₂O 312 from a pressurized tank 314 passes through a metering valve 316 where it merges with fuel 302 before passing through a high, constant pressure, on-demand pump 318. The N₂O-loaded fuel 320 then enters high pressure manifold 322, called a common rail, where its pressure is monitored by a sensor 324 before it enters individual injectors 326 which spray it, with proper timing (for example within a crankshaft angle of ±10° from top dead center) into the combustion zone of each cylinder. The desired fuel injection timing can be adjusted and controlled by an electronic engine control unit 328 similar to those commonly installed on modern vehicular diesel engines. In alternative engine designs the fuel may be fed individually to each injector, or the injectors may be timed by cams, but such designs allow the use of N₂O injection in much the same way as the common rail system shown in FIG. 3.

The metering valve 316 is under the control of an electronic system which adjusts the flow of N₂O to maintain a desired concentration in the fuel. In alternative versions of the invention the N₂O may pass through its own high pressure pump before being introduced into the high pressure fuel immediately before the fuel injectors, and the electronic control system may or may not include a processor coded to vary the N₂O concentration in response changes in engine RPM and the air-to-fuel ratio.

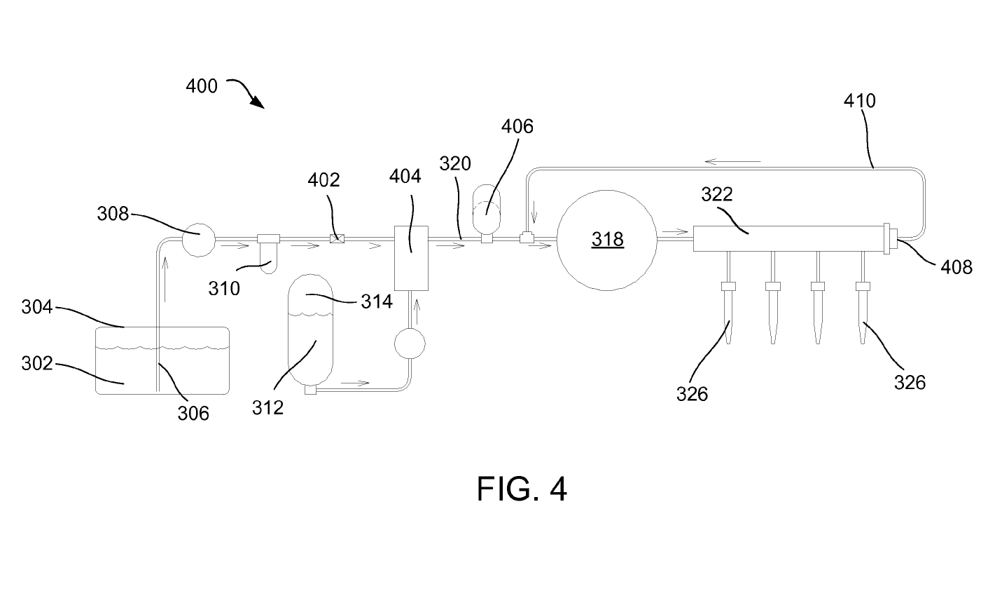

FIG. 4 shows a schematic of another embodiment of a diesel engine fuel delivery system 400 modified for addition of nitrous oxide to the fuel using an accumulator vessel to obviate the need for an on-demand constant pressure high pressure pump. Referring to FIG. 4, fuel 302 is drawn from a fuel tank 304 through an outlet tube 306 by a low pressure pump 308 and delivered through a fuel filter 310 and check valve 402 to a mixing unit 404 which blends it with a fixed proportion of liquid nitrous oxide 312 from a pressurized tank 314. The N₂O-doped fuel 320 then passes to an accumulator 406 which provides a feed stream to the high pressure pump 318, which in turn delivers N₂O-doped fuel 320 at high pressure to the common rail 322 and from there to the individual injectors 326. Excess fuel from the common rail escapes through a pressure relief valve 408 and recirculates through a return fuel line 410 to the high pressure pump 318, so only the small volume of fuel actually consumed need be replaced by the low pressure pump 308 and the accumulator 406. Check valve 402 acts as a safety to prevent N₂O-doped fuel 320 from ever returning to the fuel tank 304 to eliminate the possibility of N₂O gas accumulating in the fuel tank.

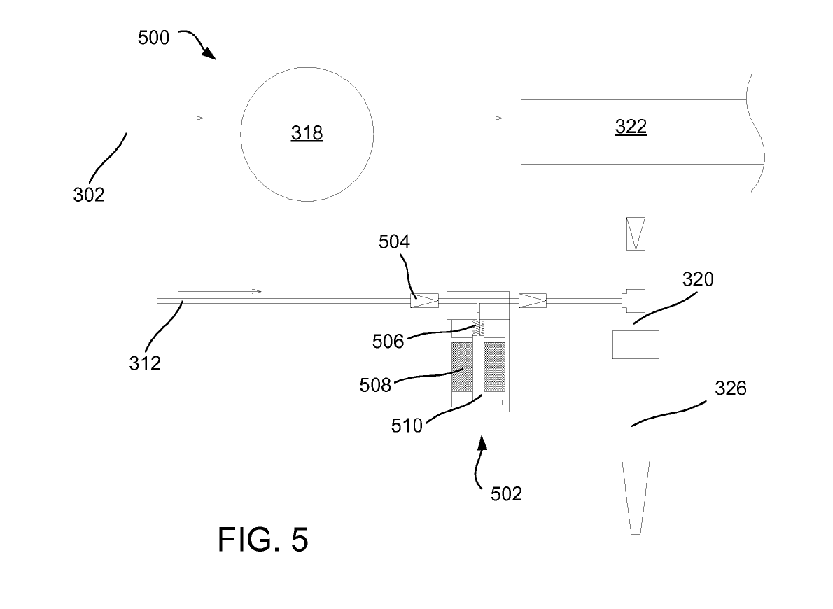

FIG. 5 shows another embodiment of a nitrous oxide delivery system 500 in which liquid N₂O under autogenous pressure is delivered by a high pressure solenoid pump directly to each fuel line on its way from the common rail to a fuel injector. Referring to FIG. 5, fuel 302 from the fuel tank is pressurized by a high pressure pump 318 and passed to a common rail 322 from which it passes through individual feed lines to the fuel injectors 326. Concurrently, liquid N₂O 312 from a pressurized holding tank passes into a small, calibrated volume, high pressure solenoid pump 502 whose pulses are adjusted to produce the desired concentration of N₂O. Solenoid pump 502 includes a solenoid return spring 506, a solenoid coil 508, and a solenoid armature 510. The pulse of high pressure nitrous oxide 312 is then blended with the fuel 302 en route to the fuel injector 326. Check valve 504 acts as a safety to prevent N₂O-doped fuel 320 from ever returning to the fuel tank to eliminate the possibility of N₂O gas accumulating in the fuel tank.

Other configurations beside those shown in these figures can be used to introduce ignition-promoting quantities of N₂O into diesel fuel.

### EXAMPLES

### Example 1

Over the course of 15 minutes, 100 grams of nitrous oxide is bubbled through 3000 grams of CN 45 diesel fuel, causing a weight gain of 10 grams, equivalent to 0.33%. A similar quantity of unmodified fuel is reserved in an identical container, and both containers are weighed. A John Deere M4024T four cylinder diesel engine mounted on a test rack and governed at 1800 RPM is rigidly connected to a 60 cycle AC Dynamo which in turn is connected to a set of four individually switchable 5 kW electrical heaters. A control panel is provided to allow RPM, current and voltage to be read in real time. Fuel consumption is monitored by weight.

The engine is started on standard diesel fuel from its own tank and allowed to reach steady state operating conditions for 15 minutes under a 5 kW load. Fuel flow is then switched to the graduated container of unmodified fuel and the engine is operated with a 5 kW load for 5 minutes, at which time flow is switched to the N₂O doped fuel for the same length of time. At the beginning and end of these operating intervals the containers are weighed. Fuel flow is then switched back to fuel from the main tank, and the engine is allowed to equilibrate for 15 minutes with a 10 kW load. The same procedure is then followed with the two containers of unmodified and modified fuel, and this sequence is again followed with 15 kW and 20 kW loads. In all cases the actual load is determined by current and voltage readings.

Table 1 shows the results of these tests.

TABLE 1

| | Unmodified Fuel | N₂O-Doped Fuel |
|---|---|---|
| Load (kW) | Consumption (gm/min) | Consumption (gm/min) |
| 0 | 18 | 14 |
| 5 | 30 | 24 |
| 10 | 60 | 49 |
| 15 | 90 | 70 |
| 20 | 120 | 98 |

Over this range of loads fuel consumption proves to be reduced between 18% and 23% when the engine is operating on fuel containing 0.33% N₂O by weight.

### Example 2

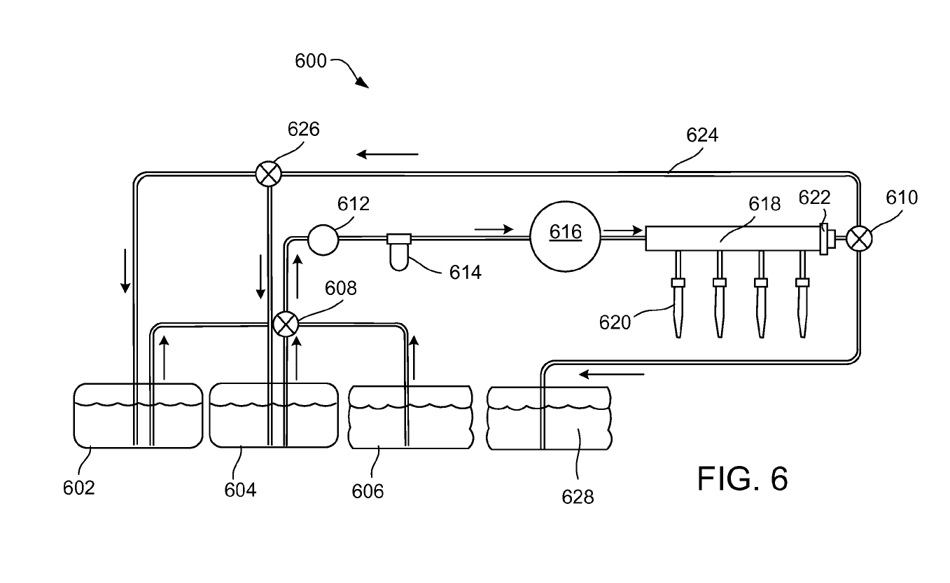

A Ford F250 truck powered by a 6.0 liter V8 Power Stroke diesel is modified as shown schematically in FIG. 6.

An experiment is conducted using experimental system 600 as follows to determine the improvement in mileage of a diesel vehicle produced by a small concentration of N₂O in the fuel. Referring to FIG. 6, at the beginning of the experiment tank 602, the truck's original fuel tank, is filled with conventional fuel having a cetane number of 45; tank number 604 is filled with 60.0 kg of the same fuel; and tank number 606 is filled with 59.79 kg of the same fuel in which 0.21 kg of N₂O (0.35% by weight) has been dissolved in a manner similar to that of example 1.

During travel to the preselected test route, valves 608 and 610 are set so as to deliver fuel from tank number 302 through the low pressure pump 612, the filter 614, and the high pressure pump 616 to the common rail 618, from which it is distributed to the individual injectors 620, with excess fuel escaping through pressure relief valve 622 and then flowing through two way valve 610, return line 624, and routing valve 626 back to fuel tank 602.

Upon the truck arriving at the starting site three way valve 608 is set so as to draw fuel from tank number 604, and two way valve 610 is set to return excess fuel back to tank number 604. The truck is immediately driven on a round trip over the 50 km test course, adhering as closely as possible to a predetermined sequence of speeds not exceeding 80 km/hr.

When once again at the starting point, valve 608 is set so as to draw N₂O-containing fuel from tank number 606, valves 610 and 626 are set so as to deliver excess fuel from the pressure relief valve 622 to waste tank number 628, and the truck is driven on a round trip over the same course adhering as nearly as possible to the same sequence of speeds. During this part of the test run, tanks 606 and 628 automatically adjust their volume so as to minimize head space over the N₂O-containing fuel, thus mitigating any slight risk of exothermic decomposition of N₂O vapor and allowing and little or no N₂O (a known greenhouse gas) to be released into the atmosphere.

At the conclusion of the experiment valves 608, 610 and 626 are returned to their initial settings so as to draw fuel from, and return fuel to, tank number 602; after which the truck is driven back to its base of operations and the weight of fuel remaining in tanks number 604, 606 and 628 is accurately determined

The mileage obtained using the two fuels is then calculated based on the 100 km total length of the course and the weight of fuel consumed, (60 kg minus the weight of fuel in tank number 604) for regular fuel and (60 kg minus the weight of fuel in tank number 606 plus the weight of fuel in tank number 628) for the N₂O-containing fuel. The results of three repetitions of this experiment show the average mileage on conventional fuel to be 17.1 mpg and the average mileage on N₂O-containing fuel to be 21.4 mpg. Thus under the conditions described here the improvement achieved by the addition of 0.35% N₂O to the fuel is 25.1%.

A number of embodiments have been described. Other embodiments are in the following claims.

What is claimed is:

1. A method for improving the efficiency of a diesel engine, comprising:
mixing nitrous oxide in diesel fuel to provide modified fuel; and timing injection of the modified fuel into a combustion chamber of the diesel engine with a cylinder stroke to enhance ignition and reduce fuel consumption of the diesel engine relative to using unmodified diesel fuel.

2. The method of claim 1, wherein the timing is selected so that ignition occurs within about 5° after top dead center.

3. The method of claim 1, wherein a concentration of nitrous oxide in the modified fuel is between 0.1% and 1.0% by weight.

4. The method of claim 1, wherein the nitrous oxide is stored as a compressed liquid in a pressurized tank prior to dissolving in the diesel fuel.

5. The method of claim 1, wherein diesel fuel is delivered to the combustion chamber first through a low pressure pump and then through a high pressure pump and the nitrous oxide, in liquid form, is introduced into the diesel fuel through a metering valve between the low pressure pump and the high pressure pump.

6. The method of claim 5, wherein a driving pressure for flow through the metering valve is an autogenous pressure of the liquid nitrous oxide.

7. The method of claim 5, wherein the diesel fuel is stored in a fuel tank and the high pressure pump is an on-demand constant pressure pump configured to prevent return of the modified fuel to the fuel tank.

8. The method of claim 5, wherein a metering valve operates based on a rate of flow of the diesel fuel to produce a constant concentration of nitrous oxide in the modified fuel.

9. The method of claim 5, where in the metering valve is keyed to the rate of flow of the diesel fuel and to a RPM and load of the engine to produce an optimum concentration of nitrous oxide in the modified fuel.

10. The method of claim 5, wherein the metering valve and the timing of fuel injection are controlled using an electronic processing system comprising stored instructions and electronic sensors that regulate injection timing and nitrous oxide concentration in the modified fuel to adjust both diesel fuel consumption and nitrous oxide consumption.

11. The method of claim 5, wherein an accumulator is included after the introduction of nitrous oxide in the fuel line between the low pressure pump and the high pressure pump.

12. The method of claim 11, wherein the high pressure pump operates at a constant volumetric rate.

13. The method of claim 12, wherein the engine delivers the modified fuel to the combustion chamber via a common rail and excess modified fuel exits the common rail through a pressure relief valve and returns to an inlet side of the high pressure pump.

14. The method of claim 1, wherein the engine comprises a common rail configured to deliver the modified fuel to the combustion chamber, one or more high-pressure solenoid pumps operated by an electronic control unit, and delivery of the mixed fuel to the combustion chamber comprises using the solenoid pumps to deliver minute, accurately calibrated pulses of N₂O to fuel lines leading from the common rail to the combustion chamber.

15. A system, comprising:
a diesel internal combustion engine comprising at least one combustion chamber; and
a means for mixing nitrous oxide in diesel fuel to form modified fuel and controlling a time at which the modified fuel is injected into the combustion chamber to enhance ignition and reduce fuel consumption of the diesel engine relative to using unmodified diesel fuel.

16. The system of claim 15, wherein the system controls the time so that resulting ignition occurs within about 5° to 10° after top dead center.

17. The system of claim 16, wherein the system mixes the nitrous oxide so that the concentration of nitrous oxide in the modified fuel is between 0.1% and 1.0% by weight.

18. The system of claim 15, comprising a pressure-resistant tank wherein the nitrous oxide is stored as a pressurized liquid.

19. The system of claim 18, comprising a metering valve for introducing the nitrous oxide into a fuel line.

20. The system of claim 19, comprising a high pressure pump and a low pressure pump for delivering diesel to the combustion chamber, wherein the metering valve is located between the low pressure pump and the high pressure pump.

21. The system of claim 20, wherein the high pressure pump is an on-demand constant pressure pump configured to prevent return of the modified fuel to a fuel tank supplying the diesel fuel.

22. The system of claim 21, comprising a means whereby the metering valve operates based on a rate of flow of the diesel fuel to produce a constant concentration of nitrous oxide in the modified fuel.

23. The system of claim 21, comprising a means whereby the metering valve operates based on a rate of flow of the diesel fuel and to a RPM and load of the engine to produce an optimum concentration of nitrous oxide in the modified fuel.

24. The system of claim 21, comprising an electronic processing system comprising stored instructions and electronic sensors which control injection timing and nitrous oxide concentration in the modified fuel adjust diesel fuel consumption and nitrous oxide consumption.

25. A system, comprising:
a diesel internal combustion engine comprising a low-pressure pump and a high-pressure pump for delivering diesel fuel to at least one combustion chamber via a common rail, the high-pressure pump being configured to operate at a constant volumetric rate;
a tank containing nitrous oxide and a supply module arranged to supply nitrous oxide from the tank to a fuel line between the low-pressure pump and the high-pressure pump, where the nitrous oxide mixes with diesel fuel in the fuel line to provide modified fuel;
an accumulator in the fuel line between the low-pressure and high-pressure pumps downstream from where the nitrous oxide is introduced; and
a return line for returning to an inlet side of the high-pressure pump modified fuel exiting the common rail through a pressure relief valve.

26. A system comprising:
a diesel internal combustion engine comprising one or more fuel injectors which receive fuel via a common rail;
a tank containing nitrous oxide;
one or more high-pressure solenoid pumps; and
an electronic control unit in communication with the high-pressure solenoid pumps,
wherein during operation the electronic control unit causes the solenoid pumps to deliver calibrated pulses of nitrous oxide to one or more fuel lines leading from the common rail to each fuel injector.
